(19) United States
(12) Patent Application Publication
(10) Pub. No.: US 2013/0027217 A1
(43) Pub. Date: Jan. 31, 2013

(54) Systems, Methods, and Apparatus for Automatically Configuring a Utility Meter

(71) Applicant: Prerna Jindia, Atlanta, GA (US)

(72) Inventor: Prerna Jindia, Atlanta, GA (US)

(73) Assignee: GENERAL ELECTRIC COMPANY, Schenectady, NY (US)

(21) Appl. No.: 13/194,514

(22) Filed: Jul. 29, 2011

(51) Int. Cl. G08B 1/08

(52) U.S. Cl. 340/870.02

(57) ABSTRACT

Certain embodiments of the invention may include systems, methods, and apparatus for automatically configuring a utility meter. According to an example embodiment of the invention, a method is provided for automatically configuring a utility meter. The method can include transmitting formatted data from a utility meter to a remote server. The formatted data includes one or more of: a ready signal, a meter identifier, a location identifier, installed options identifier, firmware version identifier, or configuration table information. The method also includes receiving configuration data from the remote server in response to the transmitted formatted data; and automatically configuring the utility meter with at least a portion of the received configuration data.

### FIELD OF THE INVENTION

This invention generally relates to utility meters, and in particular, to systems, methods, and apparatus for automatically configuring a utility meter.

### BACKGROUND OF THE INVENTION

Smart utility meters that are installed at a customer's premises usually require an initial configuration or programming, for example, to comply with the utility's rate plan, usage plan, program or contract. A technician is usually dispatched to the premises to initiate, supervise, and/or confirm the configuration process, which may involve connecting the utility meter to a computer and downloading the program files directly to the meter. If the utility meter is operable over an advanced metering infrastructure AMI, the technician may supervise the download of program files from the AMI network, and the technician may additionally verify that the meter has been properly programmed. In either case, there are costs and other drawbacks associated with sending technicians to the premises to configure the utility meter.

### BRIEF SUMMARY OF THE INVENTION

Some or all of the above needs may be addressed by certain embodiments of the invention. Certain embodiments of the invention may include systems, methods, and apparatus for automatically configuring a utility meter.

According to an example embodiment of the invention, a method is provided for automatically configuring a utility meter. The method can include transmitting formatted data from a utility meter to a remote server. The formatted data includes one or more of a ready signal, a meter identifier, a location identifier, installed options identifier, firmware version identifier, or configuration table information. The method also includes receiving configuration data from the remote server in response to the transmitted formatted data; and automatically configuring the utility meter with at least a portion of the received configuration data.

According to another example embodiment, a system is provided for automatically configuring a utility meter. The system includes a communication network; a database; a remote server connected to the communication network and in communication with the database; and a meter controller including at least one memory for storing data and computer-executable instructions; and at least one processor configured to access the at least one memory. The at least one processor is further configured to execute the computer-executable instructions for transmitting formatted data to the remote server, wherein the formatted data includes one or more of: a ready signal, a meter identifier, a location identifier, installed options identifier, firmware version identifier, or configuration table information. The at least one processor is further configured for receiving configuration data from the remote server in response to the transmitted formatted data; and automatically configuring the meter with at least a portion of the received configuration data.

According to another example embodiment, an apparatus is provided for automatically configuring a utility meter. The apparatus includes a meter controller that includes at least one memory for storing data and computer-executable instructions; and at least one processor configured to access the at least one memory and further configured to execute the computer-executable instructions for transmitting formatted data to a remote server, wherein the formatted data comprises one or more of: a ready signal; a meter identifier; a location identifier; installed options identifier; firmware version identifier; or configuration table information; receiving configuration data from the remote server in response to the transmitted formatted data; and automatically configuring the meter with at least a portion of the received configuration data.

Other embodiments, features, and aspects of the invention are described in detail herein and are considered a part of the claimed inventions. Other embodiments, features, and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a block diagram of an illustrative meter configuration system according to an example embodiment of the invention.

FIG. 2 is a block diagram of an illustrative smart meter system according to an example embodiment of the invention.

FIG. 3 depicts an example configuration table according to an example embodiment of the invention.

FIG. 4 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the invention include the automatic download of program files to a utility meter. According to certain example embodiments, the invention would not require the intervention or presence of a person in the field in order to program the utility meter. According to an example embodiment, the meter may be auto-detected. In an example embodiment, once authenticated, the meter may request and download the required program files from a database. The meter type and other meta data may be recognized by the server, and the service may return the necessary program files. According to example embodiments of the invention, if the user wants additional features, he or she may send a request by entering certain predetermined codes for required feature. These codes could be looked up via the display and keypad, and/or they may be provided in a user manual.

According to an example embodiment of the invention, programming for all of the basic features associated with the meter may be automatically downloaded based on the meter location and authentication data.

Various servers, processors, networks, etc. may be utilized for automatically configuring a utility meter, according to example embodiments of the invention, and will now be described with reference to the accompanying figures and tables.

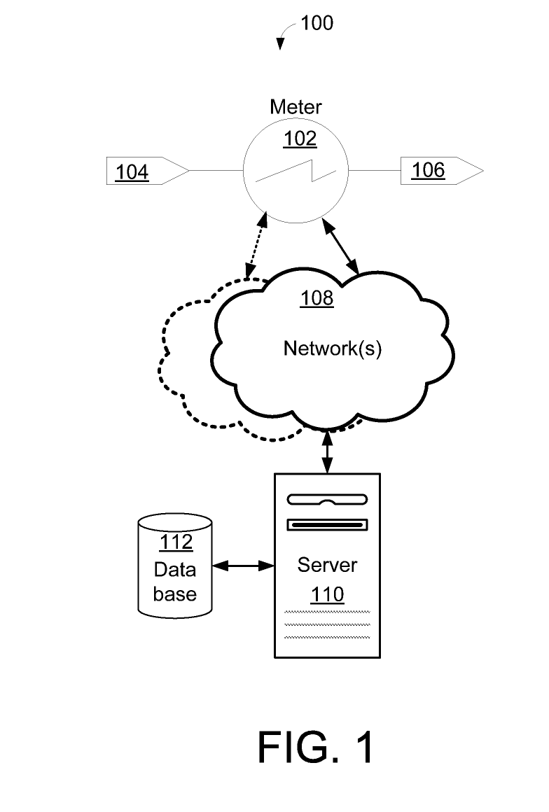

FIG. 1 illustrates a meter configuration system 100, according to an example embodiment of the invention. In accordance with example embodiments of the invention, the system 100 includes a meter 102 that may monitor voltage and/or electrical current flow between a utility 104 and a premises 106. In other embodiments, the meter may be used to measure or monitor natural gas or water flow from the utility 104 to the premises 106.

According to example embodiments of the invention, one or more networks 108 may provide one or more channels that may allow the meter 102 to communicate with a server 110. In an example embodiment, the server 110 may include a database 112. In another embodiment, the server may communicate with an external database 112. According to an example embodiment of the invention, the meter 102 may communicate with one or more servers 110 via the one or more networks 108, and the one or more servers 110 may retrieve program information from one or more databases 112. The program information from the one or more databases 112 may be sent from the server 110 to the meter 102 for programming, confirmation, and other functions associated with automatic configuration.

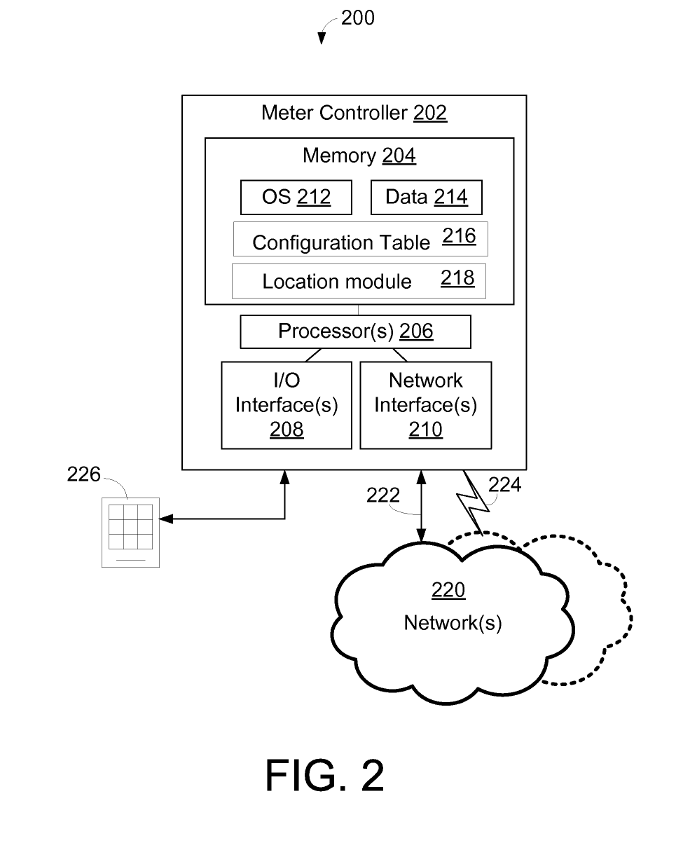

FIG. 2 depicts an example smart meter system 200, according to an example embodiment of the invention. The example system 200 can include a meter controller 202 that may be in communication with one or more networks 220 via one or more network interfaces 210 communicating via a wired connection 222 or a wireless communication channel 224. In an example embodiment, the controller 202 may include a memory 204, one or more processors 206, one or more input/output interfaces 208, and/or one or more network interfaces 210. In an example embodiment, the memory 204 may include an operating system 212, and data 214 that may be utilized by the operating system. According to an example embodiment, the memory 204 may also include a configuration table 216. In an example embodiment, the memory may include a location module 218 that may provide information that may be utilized to identify aspects of the system 200, such as the zone, locale, region and/or other location-specific data. In an example embodiment, a keypad 226 may be utilized with the system 200, for example, to allow the customer or end user to provide responses or to input data into the controller 202.

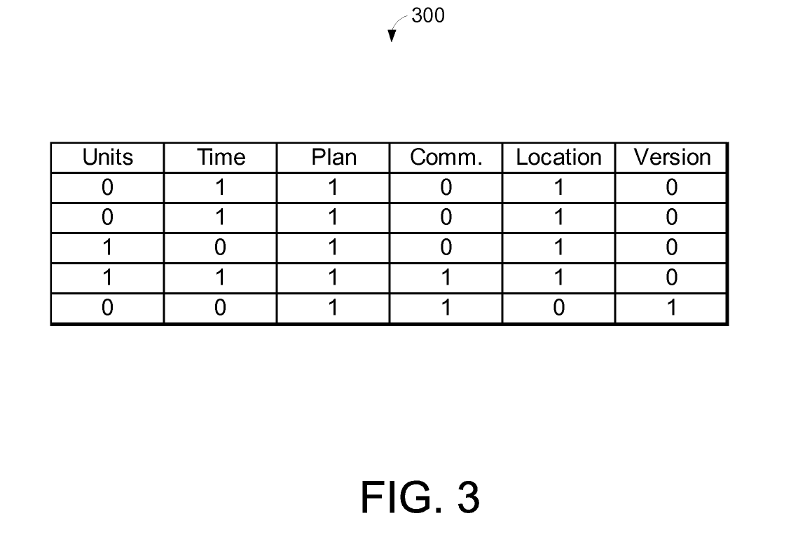

FIG. 3 depicts an example configuration table 300, according to an example embodiment of the invention. According to an example embodiment of the invention, the configuration table 300 may reside in the controller memory as in 204 of FIG. 2. In example embodiments of the invention, the configuration table may be modified during automatic configuration of the meter. For example, a server as in 110 of FIG. 1 may detect the on-line meter as in 102 of FIG. 1 and may provide data to populate the configuration table 300 within the meter. In an example embodiment, the configuration table 300 may be read by the meter to control certain aspects of the meter reading and reporting process, including but not limited to time periods, plan type, communication type, location, firmware version, etc. Other example embodiments of the configuration table 300 may include detailed information, instruction switches, or options that can be accessed by the meter operating system as in 212 of FIG. 2 in a manner similar to a lookup table or state machine.

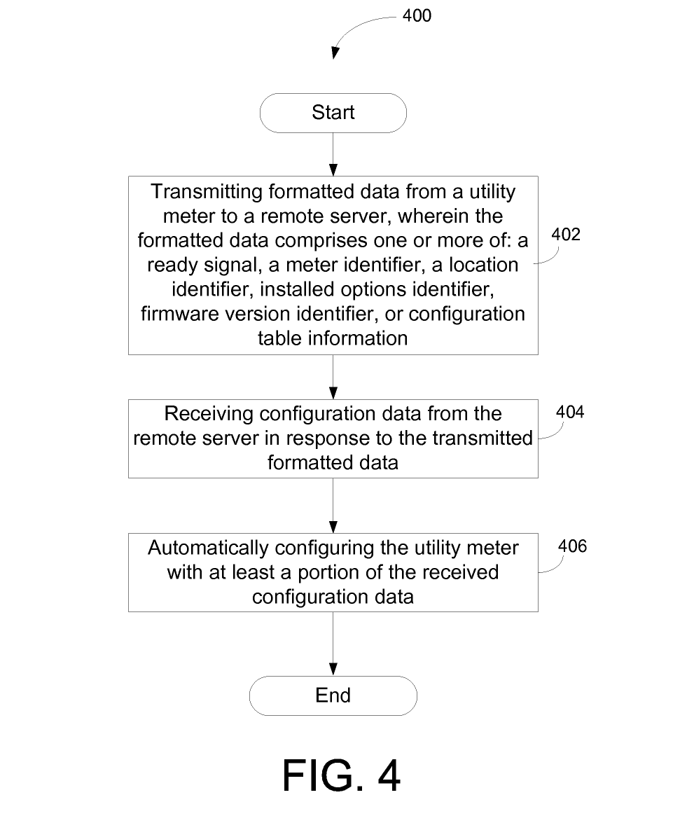

An example method 400 for automatically configuring a utility meter will now be described with reference to the flowchart of FIG. 4. The method 400 starts in block 402, and according to an example embodiment, includes transmitting formatted data from a utility meter to a remote server, wherein the formatted data comprises one or more of: a ready signal, a meter identifier, a location identifier, installed options identifier, firmware version identifier, or configuration table information. In block 404, the method 400 can include receiving configuration data from the remote server in response to the transmitted formatted data. In block 406, the method 400 can include automatically configuring the utility meter with at least a portion of the received configuration data. The method 400 ends after block 406.

According to an example embodiment, automatically configuring the utility meter 102 includes updating a configuration table 300 associated with the meter 102. In an example embodiment, transmitting formatted data to the remote server 110 includes transmitting the formatted data by a wired or wireless network 220. In an example embodiment, the method can further include initiating a meter 102 configuration process by an input device 226 associated with the meter 102. In an example embodiment, the method can further include selecting meter configuration options by an input device 226 associated with the meter 102. In an example embodiment, formatted data is automatically transmitted to the remote server 110 upon detection of a network connection 102. In an example embodiment, the method can further include receiving firmware data from the remote server 110 for updating meter firmware.

Example embodiments include a system and/or an apparatus for automatically configuring a utility meter. The system can include a communication network 220; a database 112; and a remote server 100 connected to the communication network 220 and in communication with the database 112. Example embodiments of the system and the apparatus can include a meter controller 202 having at least one memory 204 for storing data and computer-executable instructions; and at least one processor 206 configured to access the at least one memory 204 and further configured to execute the computer-executable instructions for: transmitting formatted data to the remote server 110, wherein the formatted data comprises one or more of: a ready signal, a meter identifier, a location identifier, installed options identifier, firmware version identifier, or configuration table information 300; receiving configuration data from the remote server 110 in response to the transmitted formatted data; and automatically configuring the meter 102 with at least a portion of the received configuration data.

In example embodiments, the meter controller 202 includes a configuration table 300 associated with the meter 102, wherein the configuration table is operable for being updated with at least a portion of the received configuration data. In example embodiments, the communication network 220 is wired or wireless. In example embodiments, the system or apparatus can include an input device 226 for initiating a meter 102 configuration process. In example embodiments, the system or apparatus can include an input device 226 for selecting meter configuration options. In example embodiments, the system or apparatus is further configured for automatically transmitting formatted data to the remote server 110 upon detection of a valid network connection 102. In example embodiments, the least one processor 206 is further configured for receiving firmware data from the remote server 110 for updating meter firmware.

According to example embodiments, certain technical effects can be provided, such as creating certain systems, methods, and apparatus that provide automatic configuration of a utility meter. Example embodiments of the invention can provide the further technical effects of providing systems, methods, and apparatus for bringing a meter on-line and programming it with customer or locale specific options without the need for a technician in the field.

In example embodiments of the invention, the meter configuration system 100 and the smart meter system 200 may include any number of hardware and/or software applications that are executed to facilitate any of the operations.

In example embodiments, one or more I/O interfaces may facilitate communication between the meter configuration system 100 and the smart meter system 200, and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the meter configuration system 100 and the smart meter system 200. The one or more I/O interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the meter configuration system 100 and the smart meter system 200 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ owned by Telefonaktiebolaget LM Ericsson enabled network, a Wi-Fi™ owned by Wi-Fi Alliance enabled network, a satellite-based network any wired network, any wireless network, etc., for communication with external devices and/or systems.

As desired, embodiments of the invention may include the meter configuration system 100 and the smart meter system 200 with more or less of the components illustrated in FIGS. 1 and 2.

Certain embodiments of the invention are described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for automatically configuring a utility meter, the method comprising:
transmitting formatted data from a utility meter to a remote server, wherein the formatted data comprises one or more of: a ready signal, a meter identifier, a location identifier, installed options identifier, firmware version identifier, or configuration table information;
receiving configuration data from the remote server in response to the transmitted formatted data; and
automatically configuring the utility meter with at least a portion of the received configuration data.

2. The method of claim 1, wherein automatically configuring the utility meter comprises updating a configuration table associated with the meter.

3. The method of claim 1, wherein transmitting formatted data to the remote server comprises transmitting the formatted data by a wired or wireless network.

4. The method of claim 1, further comprising initiating a meter configuration process by an input device associated with the meter.

5. The method of claim 1, further comprising selecting meter configuration options by an input device associated with the meter.

6. The method of claim 1, wherein the formatted data is automatically transmitted to the remote server upon detection of a network connection.

7. The method of claim 1, further comprising receiving firmware data from the remote server for updating meter firmware.

8. A system for automatically configuring a utility meter, the system comprising:
a communication network;
a database;
a remote server connected to the communication network and in communication with the database; and
a meter controller comprising at least one memory for storing data and computer-executable instructions; and at least one processor configured to access the at least one memory and further configured to execute the computer-executable instructions for:
transmitting formatted data to the remote server, wherein the formatted data comprises one or more of: a ready signal, a meter identifier, a location identifier, installed options identifier, firmware version identifier, or configuration table information;
receiving configuration data from the remote server in response to the transmitted formatted data; and
automatically configuring the meter with at least a portion of the received configuration data.

9. The system of claim 8, wherein the meter controller comprises a configuration table associated with the meter, wherein the configuration table is operable for being updated with at least a portion of the received configuration data.

10. The system of claim 8, wherein the communication network is wired or wireless.

11. The system of claim 8, further comprising an input device for initiating a meter configuration process.

12. The system of claim 8, further comprising an input device for selecting meter configuration options.

13. The system of claim 8, wherein the least one processor is further configured for automatically transmitting formatted data to the remote server upon detection of a valid network connection.

14. The system of claim 8, wherein the least one processor is further configured for receiving firmware data from the remote server for updating meter firmware.

15. An apparatus for automatically configuring a utility meter, the apparatus comprising:
a meter controller comprising at least one memory for storing data and computer-executable instructions; and at least one processor configured to access the at least one memory and further configured to execute the computer-executable instructions for:
transmitting formatted data to a remote server, wherein the formatted data comprises one or more of: a ready signal; a meter identifier; a location identifier; installed options identifier; firmware version identifier; or configuration table information;
receiving configuration data from the remote server in response to the transmitted formatted data; and
automatically configuring the meter with at least a portion of the received configuration data.

16. The apparatus of claim 15, wherein the meter controller comprises a configuration table associated with the meter, wherein the configuration table is operable for being updated with at least a portion of the received configuration data.

17. The apparatus of claim 15, further comprising an input device for initiating a meter configuration process.

18. The apparatus of claim 15, further comprising an input device for selecting meter configuration options.

19. The apparatus of claim 15, wherein the least one processor is further configured for automatically transmitting formatted data to the remote server upon detection of a valid network connection.

20. The apparatus of claim 15, wherein the least one processor is further configured for receiving firmware data from the remote server for updating meter firmware.
